(19) United States
(12) Patent Application Publication
(10) Pub. No.: US 2023/0169435 A1
(43) Pub. Date: Jun. 1, 2023

(54) SYSTEM AND METHODS TO FIND BEHAVIORAL INDEX WITH COACHING PRECEDENCE SCORE

(71) Applicant: NICE LTD., Ra'anana (IL)

(72) Inventors: Aniruddha PHADNIS, Pune (IN); Komal D. RAJANI, Bhopal (IN)

(21) Appl. No.: 17/539,826

(22) Filed: Dec. 1, 2021

(51) Int. Cl. G06Q 10/06; G06F 7/24

(52) U.S. Cl. CPC G06Q 10/06393; G06F 7/24

(57) ABSTRACT

Methods of providing actionable input via behavioral indexing of agents includes receiving values for a plurality of behavioral key performance indicators (KPIs) for each agent; determining a normalized behavioral score (NBS) for each behavioral KPI; receiving an assigned weight value for each behavioral KPI; transforming the assigned weight value of each behavioral KPI to a base of 4, 8, or 12; calculating a behavioral index value based on the transformed assigned weight value and NBS for each behavioral KPI; receiving a performance index value; generating a decision matrix, wherein each cell of the decision matrix holds an actionable input; placing each agent into one cell of the decision matrix; and displaying the decision matrix and the agents in each cell. A coaching need can be identified based on the decision matrix, and coaching precedence scores calculated to determine the order in which coaching should be given.

### TECHNICAL FIELD

The present disclosure relates generally to analysis of behavioral key performance indicators (KPIs), and more specifically to systems and methods for providing meaningful insights and actionable inputs on behavioral KPIs of call center agents.

### BACKGROUND

Success of a call center (also referred to herein as a contact center) is measured by the quality of the customer experience it provides and effective resolution of service requests. KPIs like First Call Resolution (FCR), Customer Satisfaction (CSAT), and Net Promoter Score (NPS) are generally used to measure overall performance of a call center workforce. These KPIs are dependent on agents' performance as well as behavioral KPIs. Currently, most contact center products focus on performance data, but provide very little data on behavioral KPIs. Therefore, behavioral KPIs are not sufficiently taken into consideration in performance evaluation of such agents. Sometimes, agent behavior and behavioral characteristics are responsible for lower performance KPI values.

Behavioral skills, however, are important in any job, and they are very important in call centers. Call center performance KPIs like CSAT, Average Handle Time (AHT), FCR, Non-Speech Time (NST), Cross Talk Time (CTT), and Empathy are dependent on behavioral skills of agents.

Possessing behavioral traits such as confidence, knowledge retention, decision-making, and negotiation with customer while on a call can result in more first call resolutions, lower hold times, lower transfer rates, and lower average handle times, which in turn can increase customer satisfaction.

Accordingly, there is a need to capture and analyze behavioral data of call center agents to better assess the performance of the agents.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a contact center according to various aspects of the present disclosure.

FIG. 2 is a more detailed block diagram of the contact center of FIG. 1 according to aspects of the present disclosure.

FIG. 3 illustrates the data flow of a method according to embodiments of the present disclosure.

FIG. 4 is a flowchart of a method according to embodiments of the present disclosure.

FIG. 5 is an exemplary graph of behavioral index and category values for an agent according to embodiments of the present disclosure.

FIG. 6 is an exemplary graph of behavioral index and category values for a team according to embodiments of the present disclosure.

FIG. 7 is an exemplary graph of behavioral index and performance index values for a team according to embodiments of the present disclosure.

FIG. 8 is an exemplary graph of coaching order of behavioral KPIs for an agent according to embodiments of the present disclosure.

FIG. 9 is a block diagram of a computer system suitable for implementing one or more components in FIG. 1 or 2 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present disclosure addresses the difficulty of generating behavioral data in call center environments. In certain embodiments, the present systems and methods provide insights on behavioral KPIs and provide actionable inputs based on generated behavioral data. Advantageously, the present disclosure provides a behavioral index value, which serves as a benchmark for all behavioral KPIs. In general, the higher the behavioral index value, the higher or the better the performance of the agent.

According to various embodiments, behavioral data for each agent is collected from multiple persons (e.g., peers, agents, supervisors, managers, customers, etc.) and/or applications (e.g., internal and/or external applications). Once the data is collected, behavioral index values are calculated for an agent, a team, or a group of agents, for various durations. In some embodiments, the person dimension (e.g., an agent, a team, or a group) and the time dimension (e.g., a week, a month, a quarter, or a year) are first selected. Based on the person and time dimension selected, the collected data for each behavioral KPI can be aggregated, and the normalized behavioral score (NBS) values determined. A use case or actionable input (e.g., reward, retention, coaching, or promotion) can also be considered with the person and time dimension selection.

In several embodiments, collected behavioral data may have a human bias, which can give misleading results. Thus, to minimize human bias, statistical techniques like random sampling or mode can be used.

In certain embodiments, based on the person and time dimensions selected, performance index values are obtained for each agent, and stored in a map (PIMap). This is a map of person and performance index value. In some embodiments, based on the person and time dimensions selected, behavioral index values for each agent are calculated and stored in a map (BIMap). This is a map of person and behavioral index values. In certain embodiments, one or more of a plurality of behavioral index values and one or more of the plurality of performance index values are stored. In various embodiments, a chart is generated from the stored behavioral index values and the stored performance index values, and the chart is displayed to a user.

In some embodiments, a decision matrix is formed using performance index values and behavioral index values. Performance KPIs and behavioral KPIs together reflect an individual's performance. In several embodiments, the decision matrix provides actionable input or insights (e.g., reward, retention, coaching, or promotion). For example, a manager or supervisor can determine what action to take based on where an agent's scores fall in the decision matrix.

In various embodiments, one or more agents require behavioral coaching or performance coaching based on their behavioral index value and/or performance index value. Managers or supervisors can identify the order of coaching for specific behavioral KPIs or performance KPIs using a coaching precedence score.

In several embodiments, coaching precedence scores are derived for all behavioral and performance KPIs to identify the order in which an agent should be coached, e.g., from most impactful to least, as measured by precedence. Coaching precedence scores can be sorted in descending order for behavioral KPIs and/or performance KPIs separately. The derived behavioral index values, performance index values, and coaching precedence scores for various time dimensions can be saved, and can be used later for reporting and dashboards. Dashboards are a type of graphical user interface that often provide at-a-glance views of KPIs relevant to a particular objective or business process.

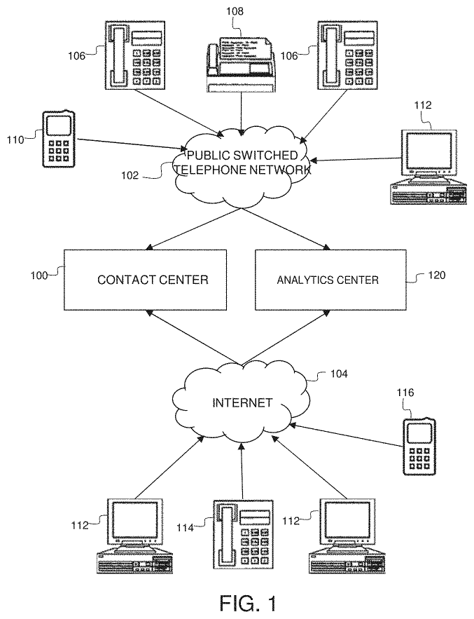

FIG. 1 is a simplified block diagram of an embodiment of a contact center 100 according to various aspects of the present disclosure. The term “contact center,” as used herein, can include any facility or system server suitable for receiving and recording electronic communications from contacts. Such contact communications can include, for example, call interactions, chats, facsimile transmissions, e-mails, web interactions, voice over IP (“VoIP”), and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a contact (or caller) and a contact center agent during fulfillment of a contact and agent transaction. In one embodiment, the contact center 100 records all of the contact interactions in uncompressed audio formats. In the illustrated embodiment, contacts may communicate with agents associated with the contact center 100 via multiple different communication networks such as a public switched telephone network (PSTN) 102 or the Internet 104. For example, a contact may initiate an interaction session through traditional telephones 106, a fax machine 108, a cellular (i.e., mobile) telephone 110, a personal computing device 112 with a modem, or other legacy communication device via the PSTN 102. Further, the contact center 100 may accept internet-based interaction sessions from personal computing devices 112, VoIP telephones 114, and internet-enabled smartphones 116 and personal digital assistants (PDAs).

As one of ordinary skill in the art would recognize, the illustrated example of communication channels associated with a contact center 100 in FIG. 1 is just an example, and the contact center may accept contact interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics center 120 before reaching the contact center 100 or may be routed simultaneously to the contact center and the analytics center (or even directly and only to the contact center). Also, in some embodiments, internet-based interactions may be received and handled by a marketing department associated with either the contact center 100 or analytics center 120. The analytics center 120 may be controlled by the same entity or a different entity than the contact center 100. Further, the analytics center 120 may be a part of, or independent of, the contact center 100.

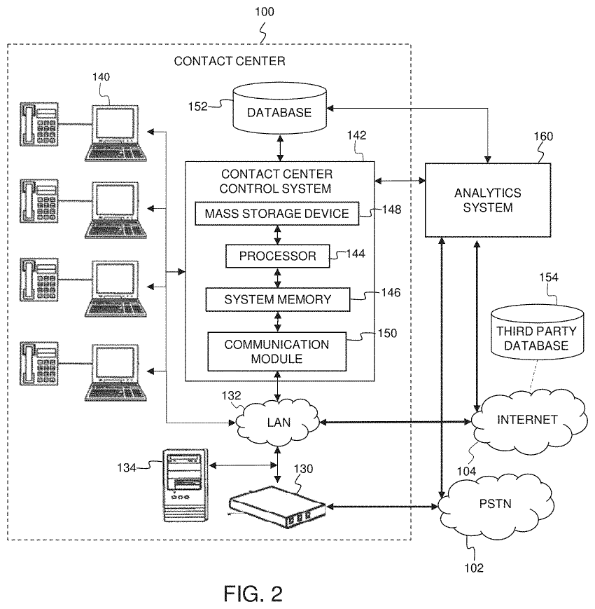

FIG. 2 is a more detailed block diagram of an embodiment of the contact center 100 according to aspects of the present disclosure. As shown in FIG. 2, the contact center 100 is communicatively coupled to the PSTN 102 via a distributed private branch exchange (PBX) switch 130 and/or ACD 130. The PBX switch 130 provides an interface between the PSTN 102 and a local area network (LAN) 132 within the contact center 100. In general, the PBX switch 130 connects trunk and line station interfaces of the PSTN 102 to components communicatively coupled to the LAN 132. The PBX switch 130 may be implemented with hardware or virtually. A hardware-based PBX may be implemented in equipment located local to the user of the PBX system. In contrast, a virtual PBX may be implemented in equipment located at a central telephone service provider that delivers PBX functionality as a service over the PSTN 102. Additionally, in one embodiment, the PBX switch 130 may be controlled by software stored on a telephony server 134 coupled to the PBX switch. In another embodiment, the PBX switch 130 may be integrated within telephony server 134. The telephony server 134 incorporates PBX control software to control the initiation and termination of connections between telephones within the contact center 100 and outside trunk connections to the PSTN 102. In addition, the software may monitor the status of all telephone stations coupled to the LAN 132 and may be capable of responding to telephony events to provide traditional telephone service. In certain embodiments, this may include the control and generation of the conventional signaling tones including without limitation dial tones, busy tones, ring back tones, as well as the connection and termination of media streams between telephones on the LAN 132. Further, the PBX control software may programmatically implement standard PBX functions such as the initiation and termination of telephone calls, either across the network or to outside trunk lines, the ability to put calls on hold, to transfer, park and pick up calls, to conference multiple callers, and to provide caller ID information. Telephony applications such as voice mail and auto attendant may be implemented by application software using the PBX as a network telephony services provider.

Often, in contact center environments such as contact center 100, it is desirable to facilitate routing of contact communications, particularly based on agent availability, prediction of profile (e.g., personality type) of the contact occurring in association with a contact interaction, and/or matching of contact attributes to agent attributes, be it a telephone-based interaction, a web-based interaction, or other type of electronic interaction over the PSTN 102 or Internet 104. In various embodiments, ACD 130 is configured to route contact interactions to agents based on availability, profile, and/or attributes.

In one embodiment, the telephony server 134 includes a trunk interface that utilizes conventional telephony trunk transmission supervision and signaling protocols required to interface with the outside trunk circuits from the PSTN 102. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The telephony server 134 includes hardware and software components to interface with the LAN 132 of the contact center 100. In one embodiment, the LAN 132 may utilize IP telephony, which integrates audio and video stream control with legacy telephony functions and may be supported through the H.323 protocol. H.323 is an International Telecommunication Union (ITU) telecommunications protocol that defines a standard for providing voice and video services over data networks. H.323 permits users to make point-to-point audio and video phone calls over a local area network. IP telephony systems can be integrated with the public telephone system through an IP/PBX-PSTN gateway, thereby allowing a user to place telephone calls from an enabled computer. For example, a call from an IP telephony client within the contact center 100 to a conventional telephone outside of the contact center would be routed via the LAN 132 to the IP/PBX-PSTN gateway. The IP/PBX-PSTN gateway would then translate the H.323 protocol to conventional telephone protocol and route the call over the PSTN 102 to its destination. Conversely, an incoming call from a contact over the PSTN 102 may be routed to the IP/PBX-PSTN gateway, which translates the conventional telephone protocol to H.323 protocol so that it may be routed to a VoIP-enable phone or computer within the contact center 100.

The contact center 100 is further communicatively coupled to the Internet 104 via hardware and software components within the LAN 132. One of ordinary skill in the art would recognize that the LAN 132 and the connections between the contact center 100 and external networks such as the PSTN 102 and the Internet 104 as illustrated by FIG. 2 have been simplified for the sake of clarity and the contact center may include various additional and/or different software and hardware networking components such as routers, switches, gateways, network bridges, hubs, and legacy telephony equipment.

As shown in FIG. 2, the contact center 100 includes a plurality of agent workstations 140 that enable agents employed by the contact center 100 to engage in contact interactions over a plurality of communication channels. In one embodiment, each agent workstation 140 may include at least a telephone and a computer workstation. In other embodiments, each agent workstation 140 may include a computer workstation that provides both computing and telephony functionality. Through the workstations 140, the agents may engage in telephone conversations with the contact, respond to email inquiries, receive faxes, engage in instant message conversations, text (e.g., SMS, MMS), respond to website-based inquires, video chat with a contact, and otherwise participate in various contact interaction sessions across one or more channels including social media postings (e.g., Facebook, LinkedIn, etc.). Further, in some embodiments, the agent workstations 140 may be remotely located from the contact center 100, for example, in another city, state, or country. Alternatively, in some embodiments, an agent may be a software-based application configured to interact in some manner with a contact. An exemplary software-based application as an agent is an online chat program designed to interpret contact inquiries and respond with pre-programmed answers.

The contact center 100 further includes a contact center control system 142 that is generally configured to provide recording, voice analysis, fraud detection analysis, behavioral analysis, text analysis, storage, and other processing functionality to the contact center 100. In the illustrated embodiment, the contact center control system 142 is an information handling system such as a computer, server, workstation, mainframe computer, or other suitable computing device. In other embodiments, the control system 142 may be a plurality of communicatively coupled computing devices coordinated to provide the above functionality for the contact center 100. The control system 142 includes a processor 144 that is communicatively coupled to a system memory 146, a mass storage device 148, and a communication module 150. The processor 144 can be any custom made or commercially available processor, a central processing unit (CPU), an auxiliary processor among several processors associated with the control system 142, a semiconductor-based microprocessor (in the form of a microchip or chip set), a microprocessor, a collection of communicatively coupled processors, or any device for executing software instructions. The system memory 146 provides the processor 144 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data, such as voice prints, may be stored on the mass storage device 148. Examples of mass storage devices may include hard discs, optical disks, magneto-optical discs, solid-state storage devices, tape drives, CD-ROM drives, and/or a variety other mass storage devices known in the art. Further, the mass storage device may be implemented across one or more network-based storage systems, such as a storage area network (SAN). The communication module 150 is operable to receive and transmit contact center-related data between local and remote networked systems and communicate information such as contact interaction recordings between the other components coupled to the LAN 132. Examples of communication modules may include Ethernet cards, 802.11 WiFi devices, cellular data radios, and/or other suitable devices known in the art. The contact center control system 142 may further include any number of additional components, which are omitted for simplicity, such as input and/or output (I/O) devices (or peripherals), buses, dedicated graphics controllers, storage controllers, buffers (caches), and drivers. Further, functionality described in association with the control system 142 may be implemented in software (e.g., computer instructions), hardware (e.g., discrete logic circuits, application specific integrated circuit (ASIC) gates, programmable gate arrays, field programmable gate arrays (FPGAs), etc.), or a combination of hardware and software.

According to one aspect of the present disclosure, the contact center control system 142 is configured to record, collect, and analyze contact voice data and other structured and unstructured data, and other tools may be used in association therewith to increase efficiency and efficacy of the contact center. As an aspect of this, the control system 142 is operable to record unstructured interactions between contacts and agents occurring over different communication channels including without limitation call interactions, email exchanges, website postings, social media communications, smartphone application (i.e., app) communications, fax messages, texts (e.g., SMS, MMS, etc.), and instant message conversations. An unstructured interaction is defined herein as a voice interaction between two persons (e.g., between an agent of the contact center 100 such as call center personnel or a chatbot, and a caller of the contact center 100, etc.) that include phrases that are not predetermined prior to the voice interaction. An example of an unstructured interaction may include the agent asking the caller “what can I help you with today,” to which the caller may answer with any possible answers. By contrast, a structured interaction is defined as a sequence of phrases between the two persons that are predetermined prior to the voice interaction. An example structured interaction may include the agent asking the caller “are you looking to change an address or withdraw money today,” to which the caller may only be able to answer based on any one of the two predetermined phrases —“change an address” or “withdraw money.”

The control system 142 may include a hardware or software-based recording server to capture the audio of a standard or VoIP telephone connection established between an agent workstation 140 and an outside contact telephone system. Further, the audio from an unstructured telephone call or video conference session (or any other communication channel involving audio or video, e.g., a Skype call) may be transcribed manually or automatically and stored in association with the original audio or video. In one embodiment, multiple communication channels (i.e., multi-channel) may be used, either in real-time to collect information, for evaluation, or both. For example, control system 142 can receive, evaluate, and store telephone calls, emails, and fax messages. Thus, multi-channel can refer to multiple channels of interaction data, or analysis using two or more channels, depending on the context herein.

In addition to unstructured interaction data such as interaction transcriptions, the control system 142 is configured to captured structured data related to contacts, agents, and their interactions. For example, in one embodiment, a “cradle-to-grave” recording may be used to record all information related to a particular telephone call from the time the call enters the contact center to the later of: the caller hanging up or the agent completing the transaction. All or a portion of the interactions during the call may be recorded, including interaction with an interactive voice response (IVR) system, time spent on hold, data keyed through the caller's key pad, conversations with the agent, and screens displayed by the agent at his/her station during the transaction. Additionally, structured data associated with interactions with specific contacts may be collected and associated with each contact, including without limitation the number and length of calls placed to the contact center, call origination information, reasons for interactions, outcome of interactions, average hold time, agent actions during interactions with the contact, manager escalations during calls, types of social media interactions, number of distress events during interactions, survey results, and other interaction information. In addition to collecting interaction data associated with a contact, the control system 142 is also operable to collect biographical profile information specific to a contact including without limitation contact phone number, account/policy numbers, address, employment status, income, gender, race, age, education, nationality, ethnicity, marital status, credit score, contact “value” data (i.e., contact tenure, money spent as contact, etc.), personality type (as determined based on past interactions), and other relevant contact identification and biological information. The control system 142 may also collect agent-specific unstructured and structured data including without limitation agent personality type, gender, language skills, technical skills, performance data (e.g., contact retention rate, etc.), tenure and salary data, training level, average hold time during interactions, manager escalations, agent workstation utilization, and any other agent data relevant to contact center performance. Additionally, one of ordinary skill in the art would recognize that the types of data collected by the contact center control system 142 that are identified above are simply examples and additional and/or different interaction data, contact data, agent data, and telephony data may be collected and processed by the control system 142.

The control system 142 may store recorded and collected interaction data in a database 152, including contact data and agent data. In certain embodiments, agent data, such as agent scores for dealing with contacts, are updated daily or at the end of an agent shift.

The control system 142 may store recorded and collected interaction data in a database 152. The database 152 may be any type of reliable storage solution such as a RAID-based storage server, an array of hard disks, a storage area network of interconnected storage devices, an array of tape drives, or some other scalable storage solution located either within the contact center or remotely located (i.e., in the cloud). Further, in other embodiments, the contact center control system 142 may have access not only to data collected within the contact center 100 but also data made available by external sources such as a third party database 154. In certain embodiments, the control system 142 may query the third party database for contact data such as credit reports, past transaction data, and other structured and unstructured data.

Additionally, in some embodiments, an analytics system 160 may also perform some or all of the functionality ascribed to the contact center control system 142 above. For instance, the analytics system 160 may record telephone and internet-based interactions, convert discussion to text (e.g., for linguistic analysis or text-dependent searching) and/or perform behavioral analyses. The analytics system 160 may be integrated into the contact center control system 142 as a hardware or software module and share its computing resources 144, 146, 148, and 150, or it may be a separate computing system housed, for example, in the analytics center 120 shown in FIG. 1. In the latter case, the analytics system 160 includes its own processor and non-transitory computer-readable storage medium (e.g., system memory, hard drive, etc.) on which to store analytics software and other software instructions.

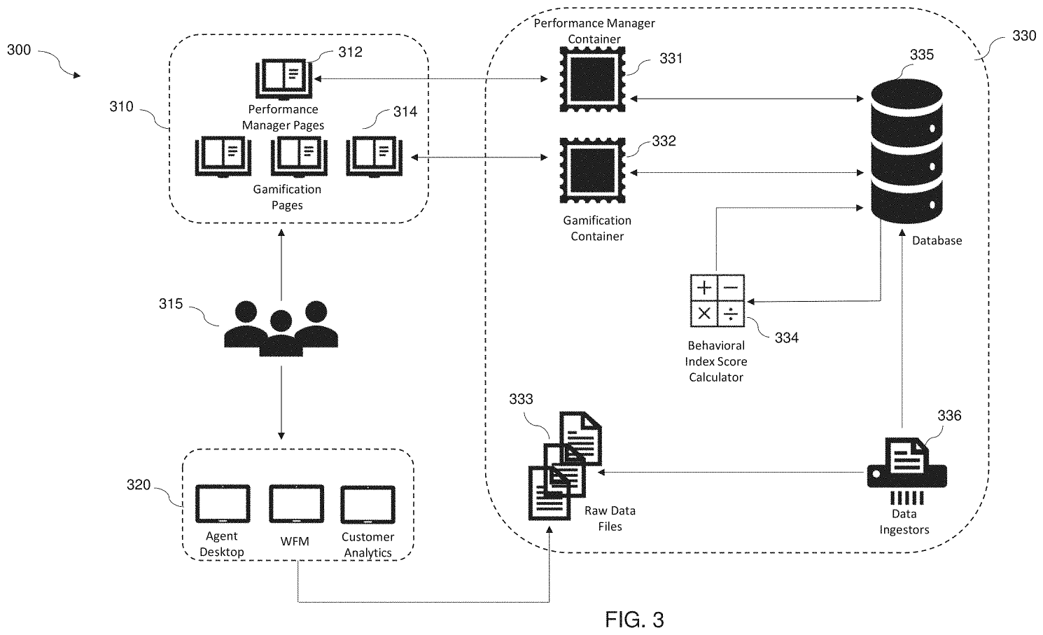

FIG. 3 illustrates the data flow to calculate behavioral index values and coaching precedence scores. End users 315 can be agents, supervisors, or managers. End users 315 access various applications for their day-to-day work, such as performance manager web application 310 and other applications 320. Performance manager web application 310 is an application that is used to monitor and improve performance of call center agents. An end user 315 can access gamification (trivia) pages 314 or performance manager pages 312 from this web application 310. Trivia can include a questionnaire with multiple choice answers.

Performance manager web application 310 contains gamification pages 314 through which a supervisor or manager creates gamification trivia that eventually gets stored in database 335. Gamification pages 314 are used to define gamification trivia, to check status of trivia completion, to check reward points awarded, and/or to redeem rewards points to buy prizes. Gamification pages 314 are served by gamification container 332. Gamification container 332 serves trivia pages and contains business logic for trivia use cases. Gamification container 332 is used to save and read trivia data from database 335. As used herein, a container is a server that hosts a web application.

Gamification pages 314 are primarily used to improve employee performance by applying gaming techniques. End users 315 can answer gamification trivia before a due date to earn reward points if the trivia is completed successfully. No reward points are credited to end users 315 if they fail in achieving the minimum passing score. Gamification container 332 analyzes the answers submitted by end users 315 and marks the trivia completed or failed for each agent in the database 335. Upon successful trivia completion, gamification container 332 updates the database 335 accordingly to reflect the current state of rewards. When end users 315 access gamification pages 314, updated information is retrieved from database 335 via gamification container 332.

In several embodiments, gamification trivia is enhanced to collect behavioral data from multiple persons (e.g., peers, supervisors, managers, and/or customers). Trivia can be scheduled per the frequency of the data collection (e.g., week, month, quarter, or year). An end user 315 submits trivia answers through gamification pages 314, and this data is sent to gamification container 332. The gamification container 332 then saves this trivia data in database 335.

Performance manager web application 310 also contains performance manager pages 312. Performance manager pages 312 render performance dashboards, workflows, and/or forms. End users 315 can view the performance dashboards, workflows, and/or forms with the help of performance manager web application 310, with web pages that are served by performance manager container 331. Performance manager container 331 contains business logic for performance manager use cases.

End users 315 can also access other applications 320. Other applications 320 include the agent desktop, workforce management (WFM), and customer analytics. The agent desktop is an application that used by call center agents to improve their interactions with customers and to track customer responses. WFM is an application that helps in achieving and maintaining operational efficiency in call centers. Customer analytics is an application that keeps track of call analytics as well as customer satisfaction. Applications 320 represent other applications that end users 315 can use for their day-to-day activities. These applications 320 generate data that can be used to derive the performance of an agent.

Agents' interactions with customers generate various raw data points that can be used to infer various performance KPI values. The raw data 333 represents raw data files that contain values of various KPIs for each agent, and act as source data for the various KPIs. The raw data 333 gets pushed onto the performance manager 330 for analysis. The data 333 gets pushed in flat files (e.g., CSV file, text file with delimiters, etc.).

Once raw data files 333 are received, performance manager 330 ingests them with the help of predefined data ingestors 336. Data ingestors 336 perform extract, transform, load (ETL) jobs. Data ingestors 336 ingest data from various sources and can transform the data into aggregated form. Data ingestors 336 transform the ingested data, analyze the data, and store the modified data in database 335. Database 335 contains different schemas for managing performance and gamification. In one embodiment, database 335 stores gamification trivia data and agent performance data.

Behavioral index score calculator 334 can be a serverless implementation like lambda, which calculates behavioral index values for each agent and coaching precedence scores when coaching recommendations are suggested by the decision matrix. In one embodiment, behavioral index score calculator 334 runs on an in-cloud infrastructure. In another embodiment, behavioral index score calculator 334 runs on a virtual machine, e.g., Amazon Web Services (AWS) Lamba or AWS Batch. This component aggregates the data per the intended duration (e.g., week/month/quarter/year) depending upon the use case, such as star of the quarter award, appraisal, rewards, retention, etc. Behavioral index score calculator 334 obtains data to calculate behavioral index value scores and coaching precedence scores from database 335. Behavioral index score calculator 334 also receives performance index values from database 335.

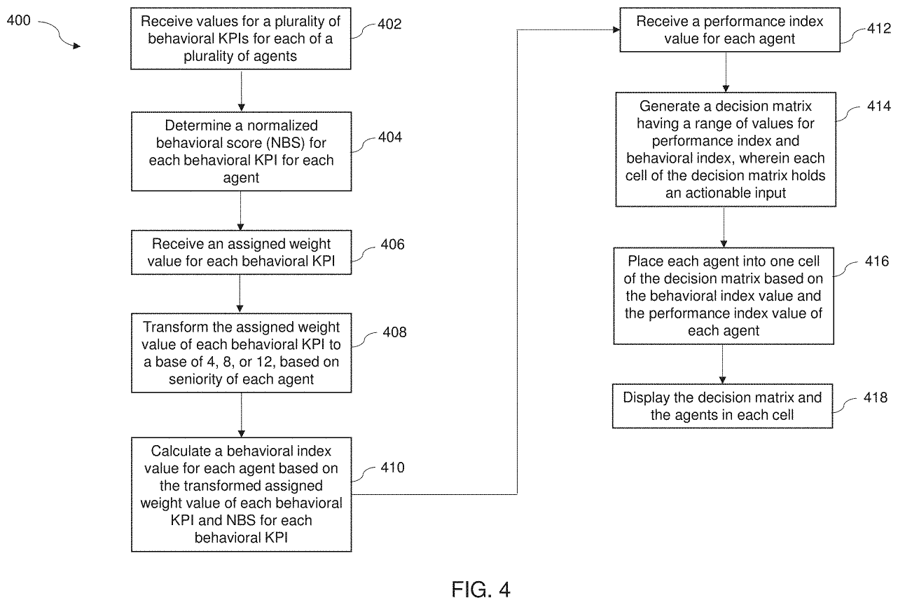

Referring now to FIG. 4, a method 400 according to embodiments of the present disclosure is described. Initially, an end user 315 may set the time dimension (e.g., a week, a month, a quarter, or a year) and the person dimension (e.g., an agent, a team, or a group) based on the use case (e.g., reward, retention, coaching, or promotion).

At step 402, behavioral index score calculator 334 receives, from gamification container 332 via database 335, values for a plurality of behavioral KPIs for each of a plurality of agents. In some embodiments, behavioral data is captured in a form of a questionnaire. These questionnaires can be completed by peers, supervisors, managers, and/or customers. In an organization, individuals are grouped into smaller teams based on the department, experience, and levels. Teammates work with each other closely and know each other's strengths and weaknesses better than supervisors. Supervisors and managers can also provide their assessment of agents' behavior. Lastly, customers who interact with agents can also provide feedback about them.

Statistical techniques like mode or random sampling can be used to minimize human bias from the collected data. The data can then be normalized for different time periods (e.g., a week, a month, a quarter, or a year) to get important insights for different groups (e.g., agents, teams, or groups).

In one embodiment, a questionnaire with multiple choice questions designed by an administrator for supervisors and agents that includes reward points if a minimum passing score is achieved is provided. Each question generally focuses on one behavioral trait, and the agent is rated on a predefined scale for a behavioral KPI. For example, a scale range could be 1-3, 1-5, or 1-10. Table 1 below is an example where there are five (5) team members Agent A to Agent E, and Agent A has rated his peers on certain behavioral KPIs for the current month.

TABLE 1
AGENT A RATING HIS PEERS

| | | Listening | | Positive |
|---|---|---|---|---|
| | Communication | Skills | Empathy | Attitude |
| Agent B | Good | Needs | Good | Needs |
| | | Improvement | | Improvement |
| Agent C | Excellent | Good | Excellent | Needs |
| | | | | Improvement |
| Agent D | Excellent | Excellent | Good | Good |
| Agent E | Good | Excellent | Excellent | Good |

Similar trivia can be assigned to all the agents periodically for behavioral data collection. The frequency of data collection can be weekly, monthly, or quarterly. The behavioral data can be normalized and aggregated using random sampling or statistical mode for each behavioral KPI for each agent to avoid human bias in collected data.

In some embodiments, the collected data is aggregated per the person dimension, the time dimension, and/or the use case. For example, if an agent needs to be chosen for “Star of the Quarter” award, then the data can be aggregated for a particular quarter. Similarly, if an agent needs to be considered for promotion then the data can be aggregated for a year or two. The idea is to aggregate the data per the decision to be made for rewards, coaching, promotion, or retention. In another example, collected data is aggregated for a group or a team of agents when the person dimension is selected to be a group or team.

In various embodiments, behavioral KPIs are categorized based on the level of experience or seniority of the agent. Behavioral KPIs should be considered in performance assessment of all agents. It can be unfair to evaluate all agents on the same set of behavioral KPIs because a few KPIs may be needed across all levels of experience, while others may be relevant after gaining certain years of experience. In one embodiment, the behavioral KPIs are grouped into three (3) categories: (1) essential KPIs, (2) exceeding KPIs, and (3) emergent KPIs.

Essential KPIs are the basic behavioral KPIs required for all agents. These KPIs should be considered in performance assessment of junior as well as senior agents. A call center agent has to interact with customers, and lack of these essential KPIs may impact even the simplest service request. KPIs such as communication, listening skills, empathy, and positive attitude fall under essential KPIs.

Exceeding KPIs are behavioral KPIs that are required in mid- to senior-level agents. These behavioral KPIs can be developed over a few years, and hence these KPIs can be disregarded in performance assessment of junior agents. KPIs such as team player, organizational ability, knowledge retention, and speed/accuracy fall under exceeding KPIs.

Emergent KPIs are behavioral KPIs that are required in senior level agents and can be considered when promoting an agent to the next level of seniority. These behavioral KPIs can be developed after spending significant time in the field, and hence these KPIs can be disregarded in performance assessment of junior and mid-level agents. KPIs such as mentoring, negotiation, composure, and creativity fall under emergent KPIs.

At step 404, behavioral index score calculator 334 determines a normalized behavioral score (NBS) for each behavioral KPI for each agent. In several embodiments, the normalized behavioral score is calculated by aggregating scores for a certain time period and obtaining an average of the score. Any other suitable method of determining an NBS could be used, as well. For example, statistical mode or random sampling may be used. In random sampling, data points are selected randomly to avoid human bias and then averaged to derive the NBS.

At step 406, behavioral index score calculator 334 receives an assigned weight value for each behavioral KPI. In some embodiments, weights are assigned to each behavioral KPI with respect to each category (e.g., essential KPI, exceeding KPI, and emergent KPI). The sum of weights for each category, in one embodiment, is one. For example, the assigned weights for mentoring, negotiation, composure, and creativity under the emergent KPI category add up to one.

In certain embodiments, behavioral index score calculator 334 calculates essential index values, exceeding index values, and emergent index values using the below formula:

$$Category = \frac{{\sum }_{i = 1}^{n} {w}_{i} \times N B {S}_{i}}{{\sum }_{i = 1}^{n} {w}_{i}}$$

Where:
Category is an essential index value, an exceeding index value, or an emergent index value.
n is the number of KPIs under each category.
wᵢ is the weight assigned in step 406 for the behavioral KPI.
NBSᵢ is the normalized behavioral score of each KPI.
Summation of weights is 1.

For example, the essential index value can be calculated as:

$$Essential Index = \frac{\begin{matrix}( {weight}_{Communication} \times N B {S}_{Communication} ) + ( {weight}_{Listening Skills} \times {NBS}_{Listening Skills} ) + \\ ( {weight}_{Empathy} \times N B {S}_{Empathy} ) + ( {weight}_{Positive Attitude} \times N B {S}_{Positive Attitude} )\end{matrix}}{{weight}_{Communication} + {weight}_{Listening Skills} + {weight}_{Empathy} + {weight}_{Positive Attitude}}$$

The exceeding index value can be calculated as:

$$Exceeding Index = \frac{\begin{matrix}( {weight}_{Team Player} \times {NBS}_{Team Player} ) + \\ ( {weight}_{Organizational Ability} \times {NBS}_{Organizational Ability} ) + \\ ( {weight}_{Knowledge Retention} \times {NBS}_{Knowledge Retention} ) + \\ ( {weight}_{Speed / Accuracy} \times {NBS}_{Speed / Accuracy} )\end{matrix}}{\begin{matrix}{weight}_{Team Player} + {weight}_{Organizational Ability} + \\ {weight}_{Knowledge Retention} + {weight}_{Speed / Accuracy}\end{matrix}}$$

The emergent index value can be calculated as:

$$Emergent Index = \frac{\begin{matrix}( {weight}_{Mentoring} \times N B {S}_{Mentoring} ) + ( {weight}_{Negotiation} \times N B {S}_{Negotiation} ) + \\ ( {weight}_{Composure} \times N B {S}_{C o m p o s u r e} ) + ( {weight}_{C reativity} \times N B {S}_{C reativity} )\end{matrix}}{{weight}_{Mentoring} + {weight}_{Negotiation} + {weight}_{Composure} + {weight}_{C reativity}}$$

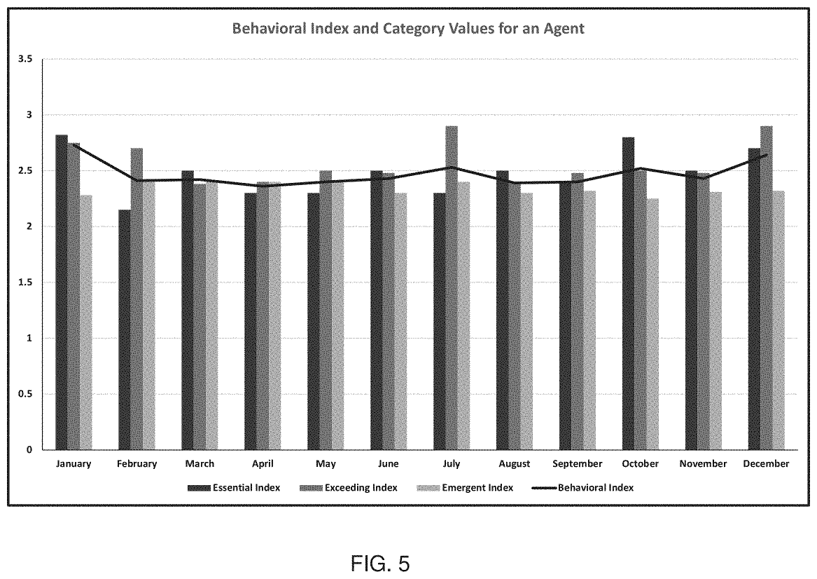

In various embodiments, behavioral index, essential index, exceeding index, and/or emergent index values can be calculated for an agent over a year. Table 2 below provides behavioral index, essential index, exceeding index, and emergent index values for Agent A for a year. FIG. 5 is a graph of the values in Table 2.

TABLE 2
ESSENTIAL INDEX, EXCEEDING INDEX, EMERGENT
INDEX, AND BEHAVIORAL INDEX VALUES FOR AGENT A
Monthly Index Values for Agent A

| | Essential | Exceeding | Emergent | Behavioral |
|---|---|---|---|---|
| | Index | Index | Index | Index |
| January | 2.82 | 2.75 | 2.28 | 2.73 |
| February | 2.15 | 2.7 | 2.4 | 2.41 |
| March | 2.5 | 2.38 | 2.4 | 2.42 |
| April | 2.3 | 2.4 | 2.4 | 2.36 |
| May | 2.3 | 2.5 | 2.4 | 2.4 |
| June | 2.5 | 2.48 | 2.3 | 2.43 |
| July | 2.3 | 2.9 | 2.4 | 2.53 |
| August | 2.5 | 2.39 | 2.3 | 2.39 |
| September | 2.4 | 2.48 | 2.32 | 2.4 |
| October | 2.8 | 2.5 | 2.25 | 2.52 |
| November | 2.5 | 2.48 | 2.31 | 2.43 |
| December | 2.7 | 2.9 | 2.32 | 2.64 |

At step 408, behavioral index score calculator 334 transforms the assigned weight value of each behavioral KPI to a base of 4, 8, or 12 based on seniority of each agent. In some embodiments, the below formula is used to transform the assigned weights:

$${T W}_{i} = \frac{{Weight}_{i} \times n}{N}$$

Where:
TWᵢ is the transformed weight for each behavioral KPI.
n is the total number of behavioral KPIs in each category.
Weightᵢ is the weight assigned in step 406 for each behavioral KPI.
N is the total number of behavioral KPIs.

For example, for an agent that is evaluated only under essential KPIs, the assigned weight value would be transformed to a base of 4; for an agent that is evaluated only on essential KPIs and exceeding KPIs, the assigned weight value would be transformed to a base of 8; and for an agent that is evaluated on essential KPIs, exceeding KPIs, and emergent KPIs, the assigned weight value would be transformed to a base of 12.

At step 410, behavioral index score calculator 334 calculates a behavioral index value for each agent based on the transformed assigned weight value of each behavioral KPI and the NBS for each behavioral KPI. In various embodiments, the behavioral index values are stored in a map of the person (e.g., agent, team, or group) vs. behavioral index value. In some embodiments, behavioral index score calculator 334 uses the below formula to determine the behavioral index value:

$$Behavioral Index = \frac{{\sum }_{i = 1}^{n} {NBS}_{i} \times T {W}_{i}}{{\sum }_{i = 1}^{n} {TW}_{i}}$$

Where:
n is the total number of behavioral KPIs.
NBSᵢ is the normalized behavioral score of each behavioral KPI.
TWᵢ is the transformed weight for each behavioral KPI
Summation of transformed weights (TW) is 1.
For junior agents, n is 4.
For mid-level agents, n is 8.
For senior agents, n is 12.

At step 412, behavioral index score calculator 334 receives a performance index value for each agent from, for example, database 335 of performance manager 330. In some embodiments, the performance index values are stored in a map of person (e.g., agent, group, or team) vs. performance index value. Performance KPIs include First Call Resolution (FCR), Customer Satisfaction (CSAT), Net Promoter Score (NPS), adherence to schedule, Average Handle Time (AHT), average caller hold time, and transfer rate.

FCR is a measure of whether customers' issues are being resolved the first time they reach out to call center agents. This value is preferred to be higher.

CSAT is a commonly used KPI to determine how satisfied customers are with a company's products or services. CSAT is typically measured at the end of a customer survey, often using a 5-point scale. Responses can vary from “highly satisfied” to “highly unsatisfied.”

NPS is a popular KPI used to measure customer experience. It can be simply measured by an answer to this question, “How likely is it that you would recommend this company to a friend or a colleague?” Other suitable NPS-like values may be used, such as a weighted net promoter score including that described in U.S. Patent Publication No. US20150134404A1, the contents of which are hereby incorporated herein by express reference thereto.

Adherence to schedule assesses how well agents manage their on-the-job time. When schedule adherence is high, that means agents are focusing most of their energy on addressing customer issues.

AHT is the elapsed time in seconds when an agent answers the call and disconnects the call. This value is preferred to be lower. At times, agents may need to put a caller on hold to speak with a supervisor or access information about the customer. While these hold times may be necessary, these need to be lower. At times, agents may need to connect customers with a supervisor to work through an issue, while other transfers direct customers to other departments. Such transfers should be kept to a minimum to minimize or avoid customer frustration and complaint(s).

For all these performance KPIs, supervisors and managers set a goal value to measure an agent's or team's performance. The input data for calculation of adherence to schedule, AHT, average caller hold time, and transfer rate is generally received from WFM and customer analytics systems, which are installed on an agent's working station. This performance goal value is used for calculation of the normalized performance score (NPS), which is a percentage to goal value. The formula for NPS differs considering whether the value of the performance KPI is higher the better or lower the better.

For cases where high performance KPI values are better, the NPS may be calculated using the below formula:

$$N P S = \frac{KPI Value}{Goal Value}$$

For cases where lower KPI values are better, the NPS may be calculated using the below formula:

$$N P S = \frac{Goal Value}{KPI Value}$$

Where:
   NPS is normalized performance score.
   KPI Value is the value of the performance KPI achieved by the agent.
   Goal Value is typically set by the supervisor/manager as a goal.

In either case, the higher the NPS, the better is the performance of the agent. The NPS values, once calculated for a unit of time duration, can be aggregated to a larger unit of time duration.

The performance index is an overall aggregated representation of an agent performance against each performance KPI and weights assigned by their organizations against each performance KPI. Performance index is calculated as a weighted average of all NPS for their respective performance KPI. For example, the performance index value can be calculated using the following formula:

$$Performance Index = \frac{{\sum }_{i = 1}^{n} {w}_{i} N P {S}_{i}}{{\sum }_{i = 1}^{n} {w}_{i}}$$

Where:
n is the number of performance KPIs.
wᵢ is the respective weight against each normalised performance score.
NPSᵢ is the normalised performance score for each respective performance KPI such as AHT, hold time, adherence to schedule, or transfer rate.

Performance KPIs and calculation of performance KPIs are described more fully in U.S. application Ser. No. 17/243,933 filed on Apr. 29, 2021 and entitled “System and Method for Finding Effectiveness of Gamification for Improving Performance of Contact Center,” the entire contents of which is incorporated herein in its entirety by express reference thereto.

At step 414, behavioral index score calculator 334 generates a decision matrix having a range of values for performance index and behavioral index, wherein each cell of the decision matrix holds an actionable input. The decision matrix provides actionable insights (e.g., coaching, rewards, retention, etc.) to supervisors and managers. A decision matrix can be of any size, such as 3×, 4×4, 5×5, etc. Each cell of the decision matrix gives a specific actionable input.

Per the size of the decision matrix, behavioral index values and performance index values can be categorized into corresponding ranges accordingly. For example, if we consider a 3×3 decision matrix, behavioral index values and performance index values are categorized into 3 ranges each. Per the performance index values and the behavioral index values, each agent falls into a cell of the decision matrix. Also, actionable inputs can be derived for an agent, team, or group based on the person dimension considered while deriving performance index values and behavioral index values. Table 3 below is an example of a 3×3 decision matrix.

TABLE 3
3X3 DECISION MATRIX

| | | | | |
|---|---|---|---|---|
| Performance Index | Best | Behavioral Coaching | Reward, | Reward, |
| | | | Advanced Behavioral | Retention, |
| | | | Coaching, | Promotion |
| | | | Retention, | |
| | | | Promotion | |
| | Good | Behavioral Coaching, | Reward, | Reward, |
| | | Advanced Performance | Advanced Behavioral | Advanced Performance |
| | | Coaching | Coaching, | Coaching, |
| | | | Performance Coaching, | Retention |
| | | | Retention | |
| | Needs | Behavioral Coaching, | Advanced Behavioral | Performance Coaching |
| | Improvement | Performance Coaching | Coaching, | |
| | | | Performance Coaching | |
| | | Needs | Good | Best |
| | | Improvement | | |

Behavioral Index

At step 416, behavioral index score calculator 334 places each agent into one cell of the decision matrix based on the behavioral index value and the performance index value of each agent. For example, Table 4 below shows the decision matrix of Table 3 with each agent (e.g., Agents A-E) placed into a cell.

TABLE 4
DECISION MATRIX WITH AGENTS

| | | | | |
|---|---|---|---|---|
| Performance Index | Best | Behavioral Coaching | Reward, | Reward, |
| | | Agent A | Advanced Behavioral | Retention, |
| | | | Coaching, | Promotion |
| | | | Retention, | Agent B |
| | | | Promotion | Agent E |
| | Good | Behavioral Coaching, | Reward, | Reward, |
| | | Advanced Performance | Advanced Behavioral | Advanced Performance |
| | | Coaching | Coaching, | Coaching, |
| | | | Performance Coaching, | Retention |
| | | | Retention | |
| | | | Agent D | |
| | Needs | Behavioral Coaching, | Advanced Behavioral | Performance Coaching |
| | Improvement | Performance Coaching | Coaching, | |
| | | Agent C | Performance Coaching | |
| | | Needs | Good | Best |
| | | Improvement | | |

Behavioral Index

At step 418, behavioral index score calculator 334 displays the decision matrix and the agents in each cell to an end user 315, e.g., a supervisor or manager, so the end user 315 can make further decisions.

In some embodiments, once a coaching need for a behavioral KPI is identified from the decision matrix, behavioral index score calculator 334 calculates coaching precedence scores for all the behavioral KPIs. In the above Table 4, Agent A, Agent C, and Agent D require behavioral coaching.

In various embodiments, once the coaching precedence score is derived for each behavioral KPI and arranged in descending order, the coaching precedence score determines the exact order of behavioral KPIs on which coaching should be given. Coaching precedence scores can be derived using the formula below:

$$C P {S}_{i} = T {W}_{i} \times 100 \times ( 1 - \frac{N B {S}_{i}}{Max score} )$$

Where:
CPSᵢ is a coaching precedence score for a behavioral KPI.
TWᵢ is the transformed weight calculated for each respective behavioral KPI.
NBSᵢ is the normalized behavioral score of the behavioral KPI aggregated for a predetermined duration.
Max score is the maximum score that can be achieved for the behavioral KPI.

In several embodiments, coaching precedence scores can be derived from performance KPIs as well. Referring back to Table 4, Agent C and Agent D are also in need of performance coaching. Coaching precedence scores can be calculated from the following formula:

$$C P {S}_{i} = {W}_{i} \times 100 \times ( 1 - \frac{N P {S}_{i}}{100} )$$

Where:
Wᵢ is the respective weight against each normalised performance score.
NPSᵢ is the normalised performance score for each respective performance KPI such as AHT,
hold time, adherence to schedule, or transfer rate.

A specific example of the method 400 will now be described in detail.

A team included ten (10) agents with different years of experience, as shown below in Table 5.

TABLE 5
TEN (10) AGENTS AND EXPERIENCE LEVELS

| | Experience Range | |
|---|---|---|
| Agent | (Years) | |
| Agent A | 4-6 | Senior |
| Agent B | | |
| Agent C | | |
| Agent D | 2-4 | Mid-Level |
| Agent E | | |
| Agent F | | |
| Agent G | 0-2 | Junior |
| Agent H | | |
| Agent I | | |
| Agent J | | |

Behavioral data for the agents was collected using gamification trivia. For example, Agent J rated his peers on various behavioral KPIs. The scale used was a numerical scale of 1-3, where 1 indicates “Needs Improvement,” 2 indicates “Good,” and 3 indicates “Excellent.” Table 6 below shows scores provided by Agent J for a month. Data can be collected, however, according to any time dimension depending on the use case.

TABLE 6
RATINGS PROVIDED BY AGENT J

| | Communi- | Listening | | Positive | Team | Organizational | Knowledge | Speed/ | Mentor- | Negotia- | Com- | Crea- |
|---|---|---|---|---|---|---|---|---|---|---|---|---|
| | cation | Skills | Empathy | Attitude | Player | Ability | Retention | Accuracy | ing | tion | posure | tivity |
| Agent A | 2 | 3 | 2 | 2 | 3 | 2 | 2 | 2 | 3 | 2 | 2 | 3 |
| Agent B | 2 | 1 | 2 | 1 | 1 | 2 | 2 | 1 | 2 | 1 | 1 | 2 |
| Agent C | 3 | 3 | 3 | 3 | 3 | 2 | 3 | 3 | 3 | 3 | 3 | 2 |
| Agent D | 3 | 3 | 2 | 2 | 3 | 3 | 2 | 3 | N/A | N/A | N/A | N/A |
| Agent E | 3 | 3 | 3 | 3 | 3 | 1 | 3 | 3 | N/A | N/A | N/A | N/A |
| Agent F | 2 | 3 | 2 | 2 | 3 | 2 | 2 | 2 | N/A | N/A | N/A | N/A |
| Agent G | 3 | 3 | 2 | 2 | N/A | N/A | N/A | N/A | N/A | N/A | N/A | N/A |
| Agent H | 3 | 3 | 3 | 3 | N/A | N/A | N/A | N/A | N/A | N/A | N/A | N/A |
| Agent I | 2 | 3 | 2 | 2 | N/A | N/A | N/A | N/A | N/A | N/A | N/A | N/A |

As described previously, mid-level agents are only rated on essential and exceeding KPIs, and junior agents are rated on essential KPIs only. Once behavioral data is collected from all the agents using trivia, statistical techniques like random sampling, mode, or average can be applied to obtain normalized scores of behavioral KPIs for each agent. Table 7 below depicts NBS of behavioral KPIs for the team over a year. The NBS values were derived from data collected through single and multiple trivia questions per the frequency of data collection.

TABLE 7
NORMALIZED BEHAVIORAL SCORES

| | Communi- | Listening | | Positive | Team | Organizational | Knowledge | Speed/ | Mentor- | Negotia- | Com- | Crea- |
|---|---|---|---|---|---|---|---|---|---|---|---|---|
| | cation | Skills | Empathy | Attitude | Player | Ability | Retention | Accuracy | ing | tion | posure | tivity |
| Agent A | 2.8 | 2.9 | 2.6 | 2.8 | 2.6 | 2.9 | 2.7 | 2.9 | 2.2 | 2.4 | 2.3 | 2.2 |
| Agent B | 2.3 | 2.4 | 2.1 | 2.2 | 2.2 | 1.9 | 2.3 | 2.1 | 1.2 | 1.8 | 1.5 | 1.8 |
| Agent C | 1.4 | 1.2 | 1.5 | 1.2 | 1.3 | 1.3 | 1.4 | 1.5 | 1.1 | 1.6 | 1.3 | 1.5 |
| Agent D | 2.6 | 2.9 | 2.7 | 2.9 | 2.8 | 2.9 | 2.6 | 2.8 | N/A | N/A | N/A | N/A |
| Agent E | 2.2 | 1.9 | 2.3 | 2.1 | 2.4 | 2.2 | 1.5 | 1.8 | N/A | N/A | N/A | N/A |
| Agent F | 1.3 | 1.3 | 1.4 | 1.5 | 1.1 | 1.6 | 1.3 | 1.5 | N/A | N/A | N/A | N/A |
| Agent G | 2.8 | 2.9 | 2.6 | 2.8 | N/A | N/A | N/A | N/A | N/A | N/A | N/A | N/A |
| Agent H | 2.5 | 2.6 | 2.8 | 2.7 | N/A | N/A | N/A | N/A | N/A | N/A | N/A | N/A |
| Agent I | 2.4 | 2.2 | 1.5 | 1.8 | N/A | N/A | N/A | N/A | N/A | N/A | N/A | N/A |
| Agent J | 1.1 | 1.6 | 1.2 | 1.5 | N/A | N/A | N/A | N/A | N/A | N/A | N/A | N/A |

Table 8 below provides the assigned weights of each behavioral KPI with respect to each category. The summation of weights with respect to each category is 1.

TABLE 8
ASSIGNED WEIGHTS

| | Behavioral KPI | Weight |
|---|---|---|
| Essential KPIs | Communication | 0.4 |
| | Listening Skills | 0.4 |
| | Empathy | 0.1 |
| | Positive Attitude | 0.1 |
| Exceeding KPIs | Team Player | 0.35 |
| | Organizational Ability | 0.15 |
| | Knowledge Retention | 0.25 |
| | Speed/Accuracy | 0.25 |
| Emergent KPIs | Mentoring | 0.3 |
| | Negotiation | 0.3 |
| | Composure | 0.2 |
| | Creativity | 0.2 |

Table 9 below depicts the transformed weights to the base of 4, to the base of 8, and to the base of 12.

TABLE 9
TRANSFORMED WEIGHTS

| | | Weight | Weight | Weight |
|---|---|---|---|---|
| | Behavioral KPI | (Base of 12) | (Base of 8) | (Base of 4) |
| Essential | Communication | 0.133 | 0.20 | 0.4 |
| KPIs | Listening Skills | 0.133 | 0.20 | 0.4 |
| | Empathy | 0.033 | 0.05 | 0.1 |
| | Positive Attitude | 0.033 | 0.05 | 0.1 |
| Exceeding | Team Player | 0.117 | 0.175 | N/A |
| KPIs | Organizational | 0.051 | 0.075 | N/A |
| | Ability | | | |
| | Knowledge | 0.083 | 0.125 | N/A |
| | Retention | | | |
| | Speed/Accuracy | 0.083 | 0.125 | N/A |
| Emergent | Mentoring | 0.1 | N/A | N/A |
| KPIs | Negotiation | 0.1 | N/A | N/A |
| | Composure | 0.067 | N/A | N/A |
| | Creativity | 0.067 | N/A | N/A |

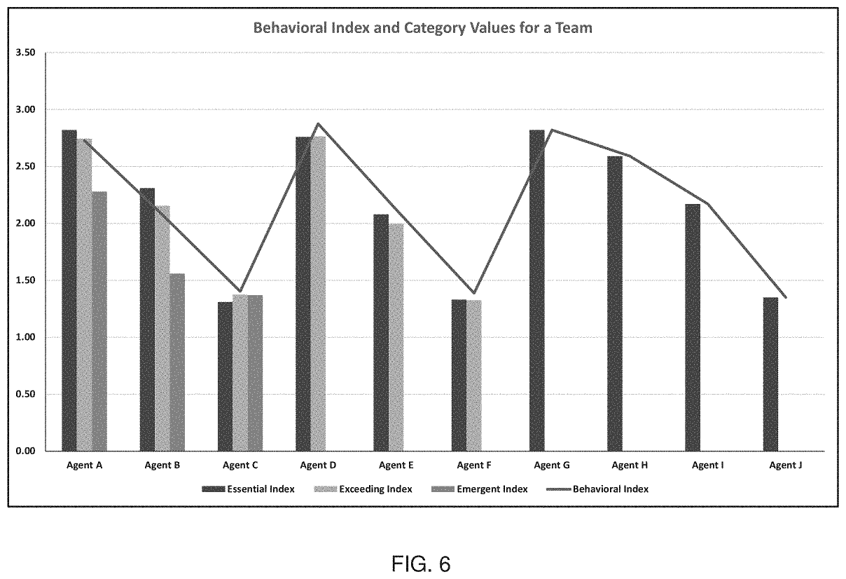

Table 10 below provides the essential index, exceeding index, emergent index, and behavioral index values for the agents. FIG. 6 is a graph of the values of Table 10 for the team (Agents A-J).

TABLE 10
ESSENTIAL INDEX, EMERGENT INDEX, EXCEEDING INDEX,
AND BEHAVIORAL INDEX VALUES FOR THE TEAM

| | Essential | Exceeding | Emergent | Behavioral |
|---|---|---|---|---|
| | Index | Index | Index | Index |
| Agent A | 2.82 | 2.75 | 2.28 | 2.73 |
| Agent B | 2.31 | 2.16 | 1.56 | 2.08 |
| Agent C | 1.31 | 1.38 | 1.37 | 1.40 |
| Agent D | 2.76 | 2.77 | N/A | 2.88 |
| Agent E | 2.08 | 2.00 | N/A | 2.12 |
| Agent F | 1.33 | 1.33 | N/A | 1.39 |
| Agent G | 2.82 | N/A | N/A | 2.82 |
| Agent H | 2.59 | N/A | N/A | 2.59 |
| Agent I | 2.17 | N/A | N/A | 2.17 |
| Agent J | 1.35 | N/A | N/A | 1.35 |

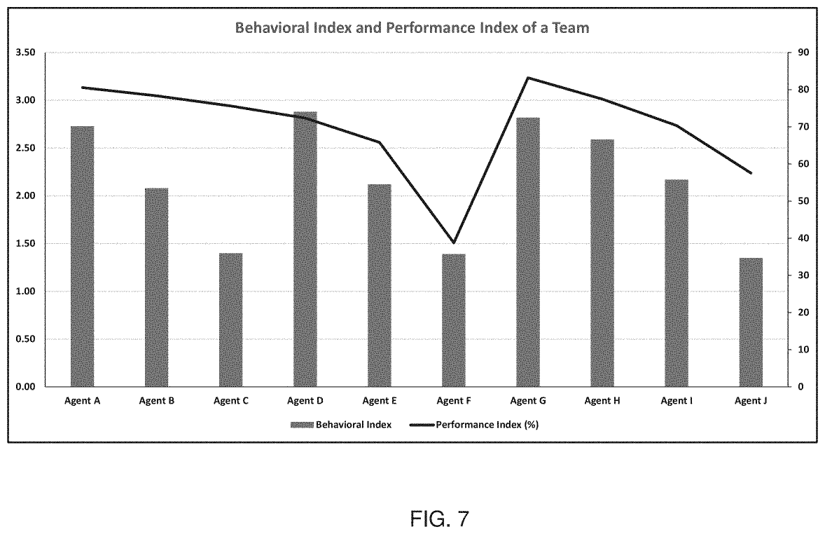

Table 11 below depicts behavioral index values and performance index values for each agent. The relevant performance KPIs (for example, AHT, CTT, NST, FCR, schedule adherence, etc.) were considered for performance index calculation. Performance index values can be obtained from the performance manager 330. FIG. 7 is a graph of the values in Table 11 for the team (Agents A-J).

TABLE 11
BEHAVIORAL INDEX AND PERFORMANCE
INDEX VALUES FOR THE TEAM

| | Behavioral Index | Performance Index (%) |
|---|---|---|
| Agent A | 2.73 | 80.56 |
| Agent B | 2.08 | 78.34 |
| Agent C | 1.40 | 75.61 |
| Agent D | 2.88 | 72.37 |
| Agent E | 2.12 | 65.78 |
| Agent F | 1.39 | 38.79 |
| Agent G | 2.82 | 83.21 |
| Agent H | 2.59 | 77.45 |
| Agent I | 2.17 | 70.32 |
| Agent J | 1.35 | 57.56 |

To form a decision matrix, performance index values were categorized into 3 ranges: (1) 0-39.9, (2) 40-74.9, and (3) 75-100. Similarly, behavioral index values were categorized into 3 ranges: (1) 0-1.49, (2) 1.5-2.49, and (3) 2.50-3. The below decision matrix shows agents placed into the respective cells per their performance index and behavioral index values.

TABLE 12
DECISION MATRIX WITH AGENTS A-J

| | | | | | |
|---|---|---|---|---|---|
| Performance Index | 75-100 | Best | Behavioral Coaching | Reward, | Reward, |
| | | | Agent C | Advanced Behavioral | Retention, |
| | | | | Coaching, | Promotion |
| | | | | Retention, | Agent A |
| | | | | Promotion | Agent G |
| | | | | Agent B | Agent H |
| | 40-74.9 | Good | Behavioral Coaching, | Reward, | Reward, |
| | | | Advanced | Advanced Behavioral | Advanced Performance |
| | | | Performance | Coaching, | Coaching, |
| | | | Coaching | Performance | Retention |
| | | | Agent J | Coaching, | Agent D |
| | | | | Retention | |
| | | | | Agent E | |
| | | | | Agent I | |
| | 0-39.9 | Needs | Behavioral Coaching, | Advanced Behavioral | Performance Coaching |
| | | Improvement | Performance | Coaching, | |
| | | | Coaching | Performance | |
| | | | Agent F | Coaching | |

| | | |
|---|---|---|
| Needs | Good | Best |
| Improvement | | |
| 0-1.49 | 1.50-2.49 | 2.50-3 |

Behavioral Index

Now assume a supervisor is asked to nominate an agent for an award like “person of the year.” By referring to the above decision matrix, the supervisor can determine that Agents A, G, and H are strong contenders for the award. To select one agent out of these contenders, the supervisor can refer to Table 11, total tenure in the organization, experience level, etc.

In another situation, the supervisor is asked to nominate an agent for promotion among senior agents. By referring to the decision matrix, the supervisor can find out that Agent A is the most eligible candidate for promotion as his performance and behavioral index values are superior to other senior agents.

In yet another situation, the supervisor is asked which agents should be retained. With reference to the decision matrix, if any agent placed in cell_{1×2}, cell_{1×3}, cell_{2×2} and cell_{2×3} of the decision matrix resigns from the organization, then the supervisor can think of retaining the agent.

In certain cells of the decision matrix (e. g., cell_{3×1}), the cell suggests an actionable input as coaching. The coaching precedence score helps supervisors/managers determine the exact order of coaching.

Consider an example of Agent C and Agent F. They belong to cell_{1×1} and cell_{3×1} respectively. Both cells of the decision matrix have an actionable input of behavioral coaching. The coaching precedence score was derived to identify the exact order of coaching for Agent C and Agent F.

In one embodiment, the coaching precedence score for the behavioral KPI of communication for Agent C was calculated as follows.

$$\begin{matrix}CP {S}_{C o m m u n i c a t i o n} = 0.13 \times 100 \times ( 1 - \frac{1.4}{3} ) \\ CP {S}_{C o m m u n i c a t i o n} = 6.93\end{matrix}$$

For each behavioral KPI, the maximum score was 3. To get the NBS of behavioral KPIs and to get the transformed weight values of behavioral KPIs, Tables 7 and 8 were referred to. Table 13 below shows the coaching precedence scores calculated for Agent C and Agent F.

TABLE 13
COACHING PRECEDENCE SCORES

Coaching Precedence Score

| Behavioral KPI | Agent C | Agent F |
|---|---|---|
| Communication | 6.93 | 11.33 |
| Listening Skills | 7.80 | 11.33 |
| Empathy | 1.50 | 2.67 |
| Positive Attitude | 1.80 | 2.50 |
| Team Player | 6.80 | 11.40 |
| Organizational Ability | 5.67 | 4.67 |
| Knowledge Retention | 4.27 | 7.37 |
| Speed/Accuracy | 4.00 | 6.50 |
| Mentoring | 6.33 | |
| Negotiation | 4.67 | |
| Composure | 3.97 | |
| Creativity | 3.97 | |

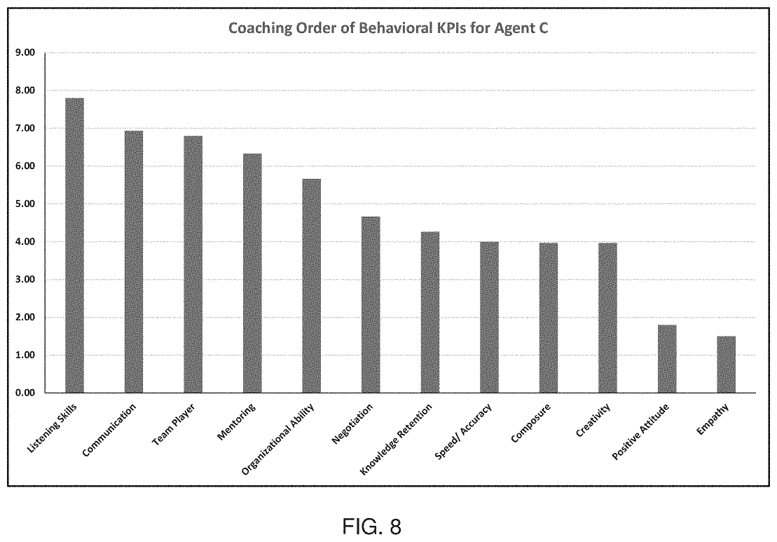

To determine the exact coaching order of behavioral KPIs for Agent C and Agent F, their coaching precedence scores were sorted in descending order. FIG. 8 is a graph of the coaching order of behavioral KPIs for Agent C.

TABLE 14
AGENT C COACHING ORDER

| Coaching Order | Agent C |
|---|---|
| Listening Skills | 7.80 |
| Communication | 6.93 |
| Team Player | 6.80 |
| Mentoring | 6.33 |
| Organizational Ability | 5.67 |
| Negotiation | 4.67 |
| Knowledge Retention | 4.27 |
| Speed/Accuracy | 4.00 |
| Composure | 3.97 |
| Creativity | 3.97 |
| Positive Attitude | 1.80 |
| Empathy | 1.50 |

TABLE 15
AGENT F COACHING ORDER

| Coaching Order | Agent F |
|---|---|
| Team Player | 11.40 |
| Communication | 11.33 |
| Listening Skills | 11.33 |
| Knowledge Retention | 7.37 |
| Speed/Accuracy | 6.50 |
| Organizational Ability | 4.67 |
| Empathy | 2.67 |
| Positive Attitude | 2.50 |

For Agent C, coaching for listening skills should be given first before other behavioral KPIs. For Agent F, coaching for being a team player should be given first before other behavioral KPIs.

Coaching precedence scores can be derived similarly for performance KPIs using the formulas described above to determine the order of coaching for performance KPIs.

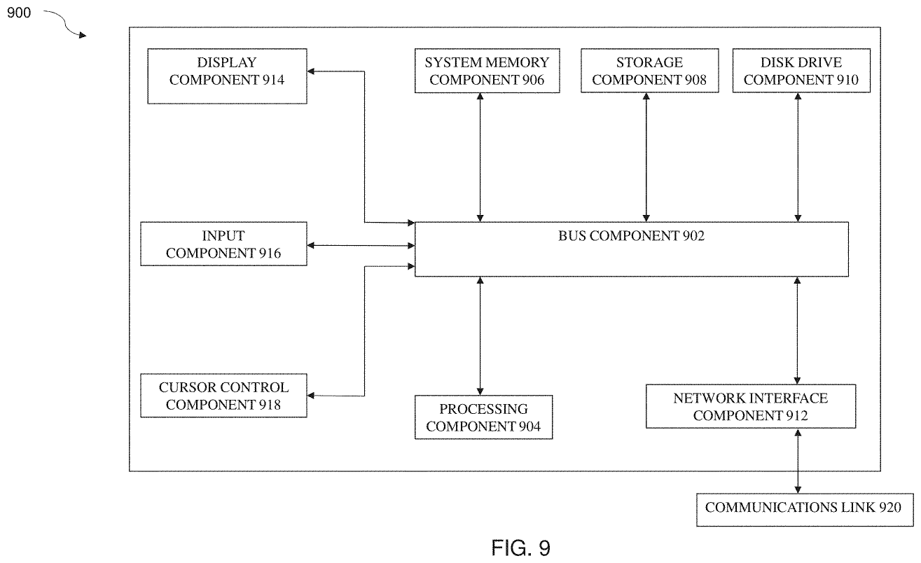

Referring now to FIG. 9, illustrated is a block diagram of a system 900 suitable for implementing embodiments of the present disclosure. System 900, such as part a computer and/or a network server, includes a bus 902 or other communication mechanism for communicating information, which interconnects subsystems and components, including one or more of a processing component 904 (e.g., processor, micro-controller, digital signal processor (DSP), etc.), a system memory component 906 (e.g., RAM), a static storage component 908 (e.g., ROM), a network interface component 912, a display component 914 (or alternatively, an interface to an external display), an input component 916 (e.g., keypad or keyboard), and a cursor control component 918 (e.g., a mouse pad).

In accordance with embodiments of the present disclosure, system 900 performs specific operations by processor 904 executing one or more sequences of one or more instructions contained in system memory component 906. Such instructions may be read into system memory component 606 from another computer readable medium, such as static storage component 908. These may include instructions to receive, from a gamification server, values for a plurality of behavioral key performance indicators (KPIs) for each of a plurality of agents; determine, by a behavioral index score calculator, a normalized behavioral score (NBS) for each behavioral KPI for each agent; receive, by the behavioral index score calculator, an assigned weight value for each behavioral KPI; transform, by the behavioral index score calculator, the assigned weight value of each behavioral KPI to a base of 4, 8, or 12, based on seniority of each agent; calculate, by the behavioral index score calculator, a behavioral index value for each agent based on the transformed assigned weight value of each behavioral KPI and NBS for each behavioral KPI; receive, by the behavioral index score calculator, a performance index value for each agent; generate, by the behavioral index score calculator, a decision matrix having a range of values for performance index and a range of values for behavioral index, wherein each cell of the decision matrix holds an actionable input; place, by the behavioral index score calculator, each agent into one cell of the decision matrix based on the behavioral index value and the performance index value of each agent; and display, by the behavioral index score calculator on a graphical user interface, the decision matrix and the agents in each cell. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 904 for execution. Such a medium may take many forms, including but not limited to, non-volatile media, volatile media, and transmission media. In various implementations, volatile media includes dynamic memory, such as system memory component 906, and transmission media includes coaxial cables, copper wire, and fiber optics, including wires that include bus 902. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 900. In various other embodiments, a plurality of systems 600 coupled by communication link 920 (e.g., networks 102 or 104 of FIG. 2, LAN 132, WLAN, PTSN, or various other wired or wireless networks) may perform instruction sequences to practice the disclosure in coordination with one another. Computer system 900 may transmit and receive messages, data, information and instructions, including one or more programs (i.e., application code) through communication link 920 and communication interface 912. Received program code may be executed by processor 904 as received and/or stored in disk drive component 910 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A behavior management system comprising:
a processor and a computer readable medium operably coupled thereto, the computer readable medium comprising a plurality of instructions stored in association therewith that are accessible to, and executable by, the processor, to perform operations which comprise:
receiving, from a gamification server, values for a plurality of behavioral key performance indicators (KPIs) for each of a plurality of agents;
determining, by a behavioral index score calculator, a normalized behavioral score (NBS) for each behavioral KPI for each agent;
receiving, by the behavioral index score calculator, an assigned weight value for each behavioral KPI;
transforming, by the behavioral index score calculator, the assigned weight value of each behavioral KPI to a base of 4, 8, or 12, based on seniority of each agent;
calculating, by the behavioral index score calculator, a behavioral index value for each agent based on the transformed assigned weight value of each behavioral KPI and NBS for each behavioral KPI;
receiving, by the behavioral index score calculator, a performance index value for each agent;
generating, by the behavioral index score calculator, a decision matrix having a range of values for performance index and a range of values for behavioral index, wherein each cell of the decision matrix holds an actionable input;
placing, by the behavioral index score calculator, each agent into one cell of the decision matrix based on the behavioral index value and the performance index value of each agent; and
displaying, by the behavioral index score calculator on a graphical user interface, the decision matrix and the agents in each cell.

2. The behavior management system of claim 1, wherein the operations further comprise:
identifying an agent in need of coaching based on the decision matrix and the agents in each cell;
calculating a coaching precedence score for each behavioral KPI for the agent in need of coaching;
sorting the calculated coaching precedence scores for each behavioral KPI in descending order to determine the exact order of coaching for each behavioral KPI; and
displaying the calculated coaching precedence scores.

3. The behavior management system of claim 1, wherein the operations further comprise:
identifying an agent in need of coaching based on the decision matrix and the agents in each cell;
receiving a normalized performance score (NPS) for each performance KPI for each agent;
receiving an assigned weight value for each performance KPI;
calculating a coaching precedence score for each performance KPI for the agent in need of coaching based on the NPS for each performance KPI for the agent and the assigned weight value for each performance KPI;
sorting the calculated coaching precedence scores for each performance KPI in descending order to determine the exact order of coaching for each performance KPI; and
displaying the calculated coaching precedence scores.

4. The behavior management system of claim 1, wherein the operations further comprise grouping the behavioral KPIs into an essential KPI category, an exceeding KPI category, or an emergent KPI category.

5. The behavior management system of claim 4, wherein communication, listening skills, empathy, and positive attitude are grouped into the essential KPI category; team player, organizational ability, knowledge retention, and speed/accuracy are grouped into the exceeding KPI category; and mentoring, negotiation, composure, and creativity are grouped into the emergent KPI category.

6. The behavior management system of claim 5, wherein the operations further comprise calculating, for each agent, a value for an essential index associated with the essential KPI category, a value for an exceeding index associated with the exceeding KPI category, or a value for an emergent index associated with the emergent KPI category, using the NBS of each behavioral KPI and the assigned weight value of each behavioral KPI.

7. The behavior management system of claim 6, wherein the operations further comprise generating a chart from a plurality of behavioral index values and a plurality of essential index values, exceeding index values, or emergent index values.

8. The behavior management system of claim 1, wherein the actionable input comprises behavioral coaching, performance coaching, reward, retention, or promotion, or a combination of any of the foregoing.

9. The behavior management system of claim 1, wherein the operations further comprise storing one or more of the plurality of behavioral index values and one or more of the plurality of performance index values.

10. The behavior management system of claim 9, further comprising generating a chart from the stored behavioral index values and the stored performance index values.

11. A method of providing actionable input via behavioral indexing of agents, which comprises:
receiving, from a gamification server, values for a plurality of behavioral key performance indicators (KPIs) for each of a plurality of agents;
determining, by a behavioral index score calculator, a normalized behavioral score (NBS) for each behavioral KPI for each agent;
receiving, by the behavioral index score calculator, an assigned weight value for each behavioral KPI;
transforming, by the behavioral index score calculator, the assigned weight value of each behavioral KPI to a base of 4, 8, or 12, based on seniority of each agent;
calculating, by the behavioral index score calculator, a behavioral index value for each agent based on the transformed assigned weight value of each behavioral KPI and NBS for each behavioral KPI;
receiving, by the behavioral index score calculator, a performance index value for each agent;
generating, by the behavioral index score calculator, a decision matrix having a range of values for performance index and a range of values for behavioral index, wherein each cell of the decision matrix holds an actionable input;
placing, by the behavioral index score calculator, each agent into one cell of the decision matrix based on the behavioral index value and the performance index value of the agent; and
displaying, by the behavioral index score calculator on a graphical user interface, the decision matrix and the agents in each cell.

12. The method of claim 11, which further comprises:
identifying an agent in need of coaching based on the decision matrix and the agents in each cell;
calculating a coaching precedence score for each behavioral KPI for the agent in need of coaching;
sorting the calculated coaching precedence scores for each behavioral KPI in descending order to determine the exact order of coaching for each KPI; and
displaying the calculated coaching precedence scores.

13. The method of claim 11, which further comprises:
identifying an agent in need of coaching based on the decision matrix and the agents in each cell;
receiving a normalized performance score (NPS) for each performance KPI for each agent;
receiving an assigned weight value for each performance KPI;
calculating a coaching precedence score for each performance KPI for the agent in need of coaching based on the NPS for each performance KPI for the agent and the assigned weight value for each performance KPI;
sorting the calculated coaching precedence scores for each performance KPI in descending order to determine the exact order of coaching for each performance KPI; and
displaying the calculated coaching precedence scores.

14. The method of claim 11, which further comprises grouping the behavioral KPIs into an essential KPI category, an exceeding KPI category, or an emergent KPI category.

15. The method of claim 14, wherein communication, listening skills, empathy, and positive attitude are grouped into the essential KPI category; team player, organizational ability, knowledge retention, and speed/accuracy are grouped into the exceeding KPI category; and mentoring, negotiation, composure, and creativity are grouped into the emergent KPI category.

16. The method of claim 11, wherein the actionable input comprises behavioral coaching, performance coaching, reward, retention, or promotion, or a combination of any of the foregoing.

17. A non-transitory computer-readable medium having stored thereon computer-readable instructions executable by a processor to perform operations which comprise:
receiving, from a gamification server, values for a plurality of behavioral key performance indicators (KPIs) for each of a plurality of agents;
determining, by a behavioral index score calculator, a normalized behavioral score (NBS) for each behavioral KPI for each agent;
receiving, by the behavioral index score calculator, an assigned weight value for each behavioral KPI;
transforming, by the behavioral index score calculator, the assigned weight value of each behavioral KPI to a base of 4, 8, or 12, based on seniority of each agent;
calculating, by the behavioral index score calculator, a behavioral index value for each agent based on the transformed assigned weight value of each behavioral KPI and NBS for each behavioral KPI;
receiving, by the behavioral index score calculator, a performance index value for each agent;
generating, by the behavioral index score calculator, a decision matrix having a range of values for performance index and a range of values for behavioral index, wherein each cell of the decision matrix holds an actionable input;
placing, by the behavioral index score calculator, each agent into one cell of the decision matrix based on the behavioral index value and the performance index value of the agent; and
displaying, by the behavioral index score calculator on a graphical user interface, the decision matrix and the agents in each cell.

18. The non-transitory computer-readable medium of claim 17, wherein the operations further comprise:
identifying an agent in need of coaching based on the decision matrix and the agents in each cell;
calculating a coaching precedence score for each behavioral KPI for the agent in need of coaching;
sorting the calculated coaching precedence scores for each behavioral KPI in descending order; and
displaying the calculated coaching precedence scores.

19. The non-transitory computer-readable medium of claim 17, wherein the operations further comprise:
identifying an agent in need of coaching based on the decision matrix and the agents in each cell;
receiving a normalized performance score (NPS) for each performance KPI for each agent;
receiving an assigned weight value for each performance KPI;
calculating a coaching precedence score for each performance KPI for the agent in need of coaching based on the NPS for each performance KPI for the agent and the assigned weight value for each performance KPI;
sorting the calculated coaching precedence scores for each performance KPI in descending order to determine the exact order of coaching for each performance KPI; and
displaying the calculated coaching precedence scores.

20. The non-transitory computer-readable medium of claim 17, wherein the actionable input comprises behavioral coaching, performance coaching, reward, retention, or promotion, or a combination of any of the foregoing.
